(19) United States
(12) Patent Application Publication
(10) Pub. No.: US 2007/0299723 A1
(43) Pub. Date: Dec. 27, 2007

(54) Method for advertising in video games played on internet enabled platforms

(75) Inventors: Daniel Willis, Stittsville (CA); Dhananjay Godse, Kanata (CA)

Correspondence Address: FISH & RICHARDSON P.C., PO BOX 1022, MINNEAPOLIS, MN, 55440-1022, US

(73) Assignee: Adscape Media Inc., San Francisco, CA (US)

(21) Appl. No.: 11/453,005

(22) Filed: Jun. 15, 2006

(51) Int. Cl. G07G 1/14; G06Q 30/00

(52) U.S. Cl. 705/14; 705/1

(57) ABSTRACT

A method for managing advertising content delivery in a gaming environment, includes a step of providing a first software package for a specific release version of a video game for a particular first platform. The first software package including computer readable code for being executed on the particular first platform. A first game identifier is embedded within the computer readable code of the first software package. Furthermore, a second software package is provided for a specific release version of a video game for a particular second platform, the second software package including computer readable code for being executed on the particular second platform. A second game identifier is embedded within the computer readable code of the second software package, the second game identifier different than the first game identifier.

### FIELD OF THE INVENTION

The instant invention relates generally to advertising in video games that are played on Internet enabled platforms, and more specifically to a method for advertising in video games that are played on Internet enabled platforms, in which plural identities are associated with a same game.

### BACKGROUND OF THE INVENTION

During recent years, computer gaming has gained increasing popularity, and today thousands of players are playing video games on Internet enabled platforms all around the world. Predictably, interactive computer gaming on Internet enabled platforms has blurred the line between video games and other entertainment or communication media, and the avenues that are being explored in the development of gaming might well break new ground for interactive Internet applications in all areas of business relations and social life.

Due to their dynamic nature and specific appeal to certain audiences video games, and especially video games played on Internet enabled platforms, provide an ideal vehicle for Internet advertising. Not only is it possible for an advertiser to target directly a specific group of customers, but also advertisements optionally are incorporated directly into the video games, enabling something akin to the well-known concept of product placement. In such a system, a game is running on a computer that is connected to the Internet. Throughout the playing of the game, the game software contacts a set of ad servers to retrieve advertising content that is available for being displayed to the gamer during game play. Typically, the game provides a unique game identifier that is associated with the game, and which identifies at least the game title and console type. The data and advertising content is transferred using HTTP protocols over the Internet. Optionally, the advertising content is cached locally to the game, and throughout the playing of the game the game software contacts a set of ad servers to retrieve a list of advertising content, selected from the cached advertising content, that is available for display to the gamer during game play.

The scheduling of advertising content delivery to a particular game is controlled by an ad service that runs the ad servers. In turn, the ad service is influenced by the game producers and by the advertisers that provide the advertising content, as well as by the game console providers. In such a system, the advertisers have a rough knowledge of how many games have been sold and roughly where they have been sold.

Often a video game containing a plurality of advertising spots has more spots than a particular advertisement service provider (ADSP) requires for achieving the goals of a particular advertising campaign. It would be advantageous for the ADSP, having reserved an advertising-enabled game, to be able to re-sell or make available any unused spots to another ADSP. As such, there is a need for a method of supporting delivery of advertising content from a plurality of different sources to advertising spots of a same game.

### SUMMARY OF EMBODIMENTS OF THE INVENTION

In accordance with an aspect of the instant invention there is provided a method for managing advertising content delivery in a gaming environment, comprising: providing a first software package for a specific release version of a video game for a particular first platform, the first software package including computer readable code for being executed on the particular first platform; embedding a first game identifier within the computer readable code of the first software package; providing a second software package for a specific release version of a video game for a particular second platform, the second software package including computer readable code for being executed on the particular second platform; and, embedding a second game identifier within the computer readable code of the second software package, the second game identifier different than the first game identifier.

In accordance with another aspect of the instant invention there is provided a method for managing advertising content delivery in a gaming environment, comprising: providing a plurality of software packages for a specific release version of a video game for a particular single platform, each software package including computer readable code for being executed on the particular single platform; embedding a first game identifier within the computer readable code of each software package of the plurality of software packages; and, embedding a second game identifier within the computer readable code of each software package of the plurality of software packages.

In accordance with another aspect of the instant invention there is provided a method for managing advertising content delivery in a gaming environment, comprising: associating a first advertising spot of an advertising enabled video game with a first game identifier of the advertising enabled video game; associating a second advertising spot of the advertising enabled video game with a second game identifier of the advertising enabled video game; receiving from the advertising enabled video game at least a communication including the first game identifier and the second game identifier; and, in response to the at least a communication including the first game identifier and the second game identifier, providing separately data relating to advertising content for being displayed using the first advertising spot of the advertising enabled video game and other data relating to advertising content for being displayed using the second advertising spot of the advertising enabled video game.

In accordance with another aspect of the instant invention there is provided a method for managing advertising content delivery in a gaming environment, comprising: providing a server in communication with a communications network; receiving at the server via the communications network, a first communication including a first game identifier associated with a particular software package for a specific release version of a video game for a particular single platform that is also in communication with the communications network; receiving at the server via the communications network, a second communication including a second game identifier associated with the particular software package; based on the first game identifier, selecting first data relating to advertising content for being displayed using an advertising spot of the video game; and, based on the second game identifier, selecting second data relating to advertising within the video game.

In accordance with another aspect of the instant invention there is provided a method for managing advertising content delivery in a gaming environment, comprising: providing a server in communication with a communications network; receiving at the server via the communications network, a first communication including a first game identifier associated with a first software package for an advertising enabled video game; receiving at the server via the communications network, a second communication including a second game identifier associated with a second software package for the advertising enabled video game; based on the first game identifier, selecting first data relating to advertising content for being displayed during execution of the first software package of the advertising enabled video game; and, based on the second game identifier, selecting second data relating to advertising content for being displayed during execution of the second software package of the advertising enabled video game.

In accordance with another aspect of the instant invention there is provided a method for managing advertising content delivery in a gaming environment, comprising: providing a first software package for a specific release version of a first video game title for a particular single platform, the first software package including computer readable code for being executed on the particular single platform; embedding a first game identifier and a second game identifier within the computer readable code of the first software package; providing a second software package for a specific release version of a second video game title for a particular single platform, the second software package including computer readable code for being executed on the particular single platform; and, embedding the first game identifier and a third game identifier within the computer readable code of the second software package, the first game identifier different than both the second game identifier and the third game identifier.

### BRIEF DESCRIPTION OF THE DRAWINGS

Embodiments of the instant invention will now be described in conjunction with the following drawings, in which:

FIG. 1 is a high-level block diagram of a broker mediated advertisable gaming system according to an embodiment of the instant invention;

FIG. 2 is a high-level block diagram of another broker mediated advertisable gaming system according to an embodiment of the instant invention;

FIG. 3 is a simplified flow diagram of a method according to an embodiment of the instant invention;

FIG. 4 is a simplified flow diagram of another method according to an embodiment of the instant invention;

FIG. 5 is a simplified flow diagram of yet another method according to an embodiment of the instant invention;

FIG. 6 is a simplified flow diagram of yet another method according to an embodiment of the instant invention;

FIG. 7 is a simplified flow diagram of yet another method according to an embodiment of the instant invention; and,

FIG. 8 is a simplified flow diagram of yet another method according to an embodiment of the instant invention.

### DETAILED DESCRIPTION OF EMBODIMENTS OF THE INVENTION

The following description is presented to enable a person skilled in the art to make and use the invention, and is provided in the context of particular applications thereof. Various modifications of the disclosed embodiments will be apparent to those of skill in the art, and the general principles defined herein are readily applied to other embodiments and applications without departing from the spirit and scope of the invention. Thus, the present invention is not intended to be limited to the embodiments disclosed, but is to be accorded the widest scope consistent with the principles and features disclosed herein.

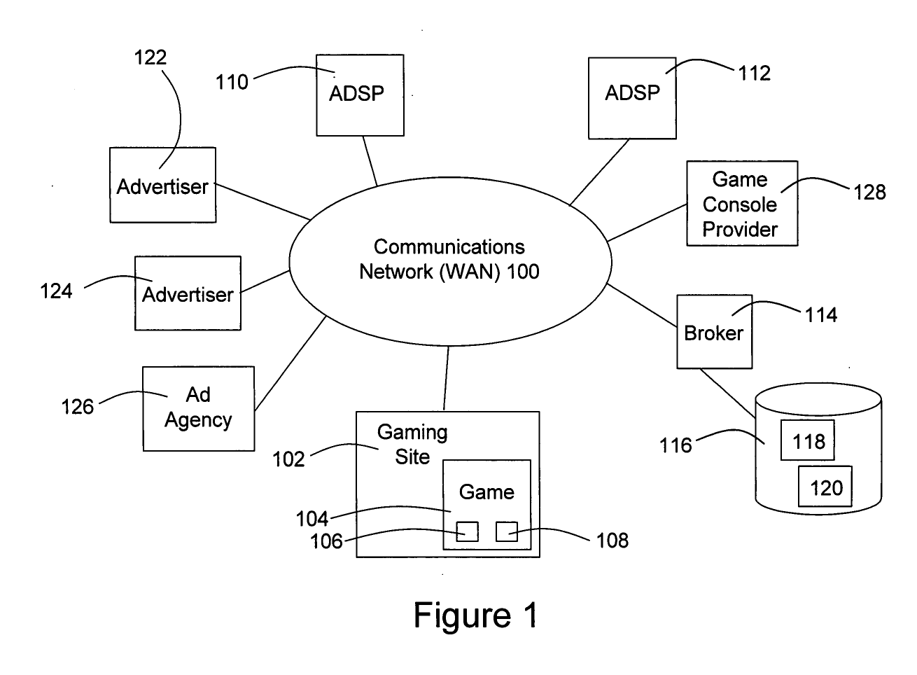

Referring to FIG. 1, shown is a high-level block diagram of a broker mediated advertisable gaming system according to an embodiment of the instant invention. A computer system, otherwise referred to as a game platform, located at gaming site 102 is connected to a communications network 100. For instance, the communications network 100 is an Internet Protocol Wide Area Network (WAN). A user at gaming site 102 purchases game software and connects to the communications network 100 to play game 104 with other likeminded individuals. Optionally, the user plays game 104 on their own, but the game platform still connects to the communications network 100 at least some of the time. As will be apparent to one of skill in the art, the game software is loaded onto the computer system that is located at gaming site 102. The game software optionally is loaded from a portable storage medium such as a compact disc, or is loaded from a remote server via the communications network 100.

The game software includes a plurality of game identifiers, which are embedded in the game software at the time the game software is built. In the instant example, game 104 includes a first game identifier 106 and a second game identifier 108. Optionally, at least one game identifier is unique to a particular software package. In other words, each different software package for a same game title includes at least one completely unique identifier. Further optionally, at least one game identifier is unique only to a particular game title and game platform combination. In a first specific and non-limiting example game identifier 106 and game identifier 108 are different game identifiers, both of which are completely unique to the specific software package in execution on the game platform at gaming site 102. In a second specific and non-limiting example, game identifier 106 is unique to the specific software package in execution on the game platform at gaming site 102, whilst game identifier 108 is unique only to the combination of game title and game platform type associated with gaming site 102. In a third specific and non-limiting example, game identifier 106 and game identifier 108 are different game identifiers, both of which are unique only to the combination of game title and game platform type associated with gaming site 102. Further optionally, more than two game identifiers are embedded in the game software when the game software is built.

Advertising service provider (ADSP) 110 and ADSP 112 also are connected to WAN 100. ADSP 110 and ADSP 112 each implement one or more ad campaigns at a time. In the case of plural ad campaigns, ADSP 110 and ADSP 112 each schedule delivery of advertising content that is provided by different advertisers, to a limited number of available spots within an instance of game 104 at gaming site 102. Clearly, it is a complex task managing and scheduling advertising content that is selected from a plurality of different advertising campaigns, being implemented by a plurality of different ADSPs, for serving impressions at advertising spots within game 104. Providing an advertising broker site 114, which also is connected to communications network 100, facilitates efficient execution of these processes. The advertising broker site 114 includes a storage portion 116 for storing an inventory 118 containing characteristic information for registered games and business logic that integrates gaming site 102 with ADSP 110 and ADSP 112, as well as for storing other data 120. In this way, the advertising broker site 114 acts as an intermediary between gaming site 102 and ADSP 110 and/or ADSP 112, as described for instance in U.S. Provisional Patent Application 60/636,543, filed on Dec. 17, 2004 and in a co-pending U.S. patent application claiming priority therefrom and filed on Dec. 19, 2005, the entire contents of both of which are incorporated herein by reference.

Optionally, advertisers 122 and 124 also are connected to communications network 100. Advertisers 122 and 124 optionally provide content directly to ADSP 110 and/or ADSP 112 via the communications network 100, or utilize the services of an ad agency 126. The ad agency 126 acts as an intermediary between the advertisers and the advertising service providers. Further optionally, at least one game console provider 128 also is connected to the communications network 100.

Additionally, storage portion 116 is shown in FIG. 1 as a unitary storage unit, but optionally includes any number of independent or inter-related storage elements, including but not limited to local hard disk drives, network drives, storage tapes, and other storage elements that are located either local to or remote from advertising broker site 114. Furthermore, the connections to communications network 100 that are shown in FIG. 1 optionally include physical connections or wireless connections, such as a satellite communication channel, a radio-frequency connection or a free-space optical connection, and various combinations of physical and wireless connections also are envisaged.

According to FIG. 1, a plurality of game identifiers is provided for each software package for a particular game title. Other software packages for the same game title also have a plurality of game identifiers associated therewith. Optionally, each software package for a particular game title is provided with a unique game identifier that is not associated with any other software package. Further optionally, each software package is provided with a common game identifier, which is common to all software packages for a particular game title. Further optionally, a subset of software packages for a particular game title, such as for instance a specific version of the game title, is provided with a common game identifier. In the latter case, different versions of the game title are provided with different common game identifiers.

Each different game identifier supports separate communication between game 104 and the other entities shown in FIG. 1. Optionally, advertising spots of game 104 are grouped according to predetermined criteria, with some spots being associated with a first game identifier, other spots being associated with a second game identifier, etc. In this way, game 104 “identifies” itself more than once during communication with advertising broker site 114, one time using each different game identifier. There are now two separate paths for communicating with game 104, each path being separate from the other. Using one path, advertising content is provided for being displayed at spots within game 104 that are associated with one of the plurality of game identifiers. Using another path, other advertising content is provided for being displayed at other spots within game 104 that are associated with another of the plurality of game identifiers. One path optionally is disabled without affecting the other path. Furthermore, optionally primary advertising spots are associated with a first game identifier and wholesaled spots are associated with at least a second game identifier. In this way, a leaseholder ADSP provides content to advertising spots associated with the first game identifier, and another ADSP provides content to wholesaled advertising spots associated with a second game identifier. Since the second ADSP hosts and delivers content directly to the advertising spots of game 104, and since the communication path associated with the second game identifier is separate from the communication path associated with the first game identifier, the problem of protecting proprietary content from tampering or viewing by unauthorized entities is solved.

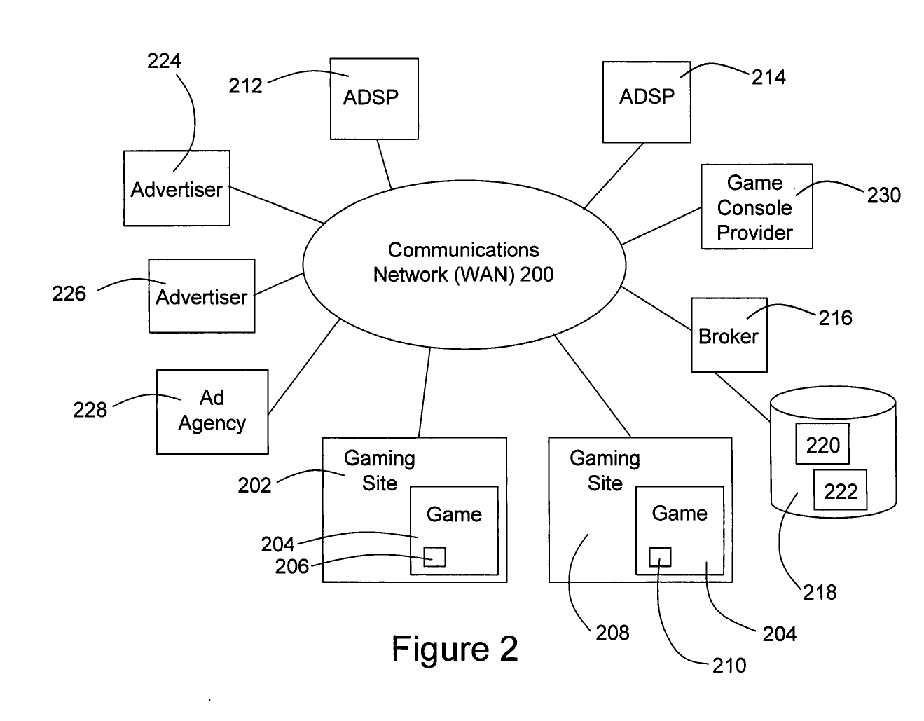

Referring now to FIG. 2, shown is a high-level block diagram of another broker mediated advertisable gaming system according to an embodiment of the instant invention. A computer system, otherwise referred to as a game platform, located at gaming site 202 is connected to a communications network 200. For instance, the communications network 200 is an Internet Protocol Wide Area Network (WAN). A user at gaming site 202 purchases game software and connects to the communications network 200 to play game 204 with other likeminded individuals. Optionally, the user plays game 204 on their own, but the game platform still connects to the communications network 200 at least some of the time. As will be apparent to one of skill in the art, the game software is loaded onto the computer system that is located at gaming site 202. The game software optionally is loaded from a portable storage medium such as a compact disc, or is loaded from a remote server via the communications network 200.

The game software in execution at gaming site 202 includes a game identifier 206, which is embedded in the game software at the time the game software is built. Optionally, the game identifier 206 is unique to the particular software package in execution on the game platform at gaming site 202. Further optionally, the game identifier 206 is unique only to a specific version of the software package in execution on the game platform at gaming site 202.

Similarly, a user at gaming site 208 purchases game software and connects to the communications network 200 to play game 204 with other likeminded individuals. Optionally, the user plays game 204 on their own, but the game platform still connects to the communications network 200 at least some of the time. As will be apparent to one of skill in the art, the game software is loaded onto the computer system that is located at gaming site 208. The game software optionally is loaded from a portable storage medium such as a compact disc, or is loaded from a remote server via the communications network 200.

The game software in execution at gaming site 208 includes a game identifier 210, which is embedded in the game software at the time the game software is built. Optionally, the game identifier 210 is unique to the particular software package in execution on the game platform at gaming site 208. Further optionally, the game identifier 210 is unique to a specific version of the software package in execution on the game platform at gaming site 208. In the example that is shown in FIG. 2 the same game title, game 204, is in execution on game platforms located at both of gaming site 202 and gaming site 208. Optionally, each instance of game 204 includes additional game identifiers.

Advertising service provider (ADSP) 212 and ADSP 214 also are connected to WAN 200. ADSP 212 and ADSP 214 each implement one or more ad campaigns at a time. In the case of plural ad campaigns, ADSP 212 and ADSP 214 each schedule delivery of advertising content that is provided by different advertisers, to a limited number of available spots within game 204 at gaming sites 202 and 208. Clearly, it is a complex task managing and scheduling advertising content that is selected from a plurality of different advertising campaigns, being implemented by a plurality of different ADSPs, for serving impressions at advertising spots within game 204. Providing an advertising broker site 216, which also is connected to communications network 200, facilitates efficient execution of these processes. The advertising broker site 216 includes a storage portion 218 for storing an inventory 220 containing characteristic information for registered games and business logic that integrates the gaming sites 202 and 208 with ADSP 212 and ADSP 214, as well as for storing other data 222. In this way, the advertising broker site 216 acts as an intermediary between gaming sites 202 and 208 and ADSP 212 and/or ADSP 214, as described for instance in U.S. Provisional Patent Application 60/636,543, filed on Dec. 17, 2004 and in a co-pending U.S. patent application claiming priority therefrom and filed on Dec. 19, 2005, the entire contents of both of which are incorporated herein by reference.

Optionally, advertisers 224 and 226 also are connected to communications network 200. Advertisers 224 and 226 optionally provide content directly to ADSP 212 and/or ADSP 214 via the communications network 200, or utilize the services of an ad agency 228. The ad agency 228 acts as an intermediary between the advertisers and the advertising service providers. Further optionally, at least one game console provider 230 also is connected to the communications network 200.

Additionally, storage portion 218 is shown in FIG. 2 as a unitary storage unit, but optionally includes any number of independent or inter-related storage elements, including but not limited to local hard disk drives, network drives, storage tapes, and other storage elements that are located either local to or remote from advertising broker site 216. Furthermore, the connections to communications network 200 that are shown in FIG. 2 optionally include physical connections or wireless connections, such as a satellite communication channel, a radio-frequency connection or a free-space optical connection, and various combinations of physical and wireless connections are envisaged.

According to FIG. 2, a plurality of different game identifiers is provided for a particular game title. Optionally, each software package for a particular game title is provided with a unique game identifier that is not associated with any other software package. Further optionally, a first game identifier of the plurality of different game identifiers is associated with a first set of software packages for a particular game title, and a second game identifier of the plurality of different game identifiers is associated with a second set of software packages for the particular game title. For instance, all copies that are sold of a first version of the game title are embedded with a common first game identifier, and all copies that are sold of a second version of the game title are embedded with a common second game identifier.

### EXAMPLES

Several specific and non-limiting examples are provided, in order to describe and particularly point out features of embodiments of the instant invention. The examples that follow are not intended to be an exhaustive list of examples, and one skilled in the art will recognize other specific implementations and applications of the embodiments of the instant invention.

### Example 1

A specific software package for a particular game title is provided with a plurality of different game identifiers, for instance two different game identifiers. When in execution on an Internet enabled gaming platform the game identifies itself to an advertising broker site two times, one time using each of the two different game identifiers. The two different game identifiers provide two communication paths to the advertising broker site, each communication path separate from the other. Accordingly, information relating to advertising content that is provided to the game via one of the two communication paths is independent of information relating to advertising content that is provided to the game via the other of the two communication paths. Optionally, a subset of advertising spots within the game is assigned to a first game identifier, and the remaining advertising spots are assigned to a second game identifier. For instance, a provider of the game title uses the communication path that is associated with the first game identifier to provide advertising content for display at the subset of advertising spots, whilst all other advertising content is provided via the communication path that is associated with the second game identifier to provide advertising content for display at the remaining advertising spots.

### Example 2

A specific software package for a particular game title is provided with a plurality of different game identifiers, for instance two different game identifiers. When in execution on an Internet enabled gaming platform the game identifies itself to an advertising broker site two times, one time using each of the two different game identifiers. The two different game identifiers provide two communication paths to the advertising broker site, each communication path separate from the other. Accordingly, information relating to advertising content that is provided to the game via one of the two communication paths is independent of information relating to advertising content that is provided to the game via the other of the two communication paths. Optionally, a subset of advertising spots within the game is assigned to a first game identifier, and the remaining advertising spots are assigned to a second game identifier. For instance, a leaseholder ADSP uses the communication path that is associated with the first game identifier to provide advertising content for display at the subset of advertising spots, more specifically the primary advertising spots. A second ADSP uses the communication path that is associated with the second game identifier to provide advertising content for display at the remaining spots, more specifically those spots that have been wholesaled by the leaseholder ADSP. The advertising broker site simply responds to a request from the game for advertising content by providing instructions to use the first game identifier to authenticate with the leaseholder ADSP and to use the second game identifier to authenticate with the second ADSP.

### Example 3

A specific software package for a particular game title is provided with a plurality of different game identifiers, for instance two different game identifiers. When in execution on an Internet enabled gaming platform the game identifies itself to an advertising broker site two times, one time using each of the two different game identifiers. The two different game identifiers provide two communication paths to the advertising broker site, each communication path separate from the other. Accordingly, information relating to advertising content that is provided to the game via one of the two communication paths is independent of information relating to advertising content that is provided to the game via the other of the two communication paths. Optionally, a subset of advertising spots within the game is assigned to a first game identifier, and the remaining advertising spots are assigned to a second game identifier. For instance, the different communication paths are used to deliver different advertising content formats. For instance, the communication path associated with the first game identifier is used to deliver a standard advertising content format and the communication path associated with the second game identifier is used to deliver advertising content having a special, promotional format. By way of a non-limiting example, the first game identifier identifies the game title and game platform, whilst the second game identifier is completely unique to the specific software package of that game title. The second game identifier is used to authenticate with a remote server, and to establish a communication path for receiving the promotional advertising content. The promotional advertising content, for instance, instructs the user to perform an action outside of the game, such as for instance buying a product to obtain a code. Once the action has been performed and the code has been obtained, the user provides the code within the game at an advertising spot associated with the second game identifier, and the result is communicated to the remote server via the communication path associated with the second game identifier.

### Example 4

A specific software package for a particular game title is provided with a plurality of different game identifiers, for instance two different game identifiers. When in execution on an Internet enabled gaming platform the game identifies itself to an advertising broker site two times, one time using each of the two different game identifiers. The two different game identifiers provide two communication paths to the advertising broker site, each communication path separate from the other. Accordingly, information relating to advertising content that is provided to the game via one of the two communication paths is independent of information relating to advertising content that is provided to the game via the other of the two communication paths. Optionally, a subset of advertising spots within the game is assigned to a first game identifier, and the remaining advertising spots are assigned to a second game identifier. For instance, the different communication paths are used to support user content delivery control functionality. For instance, the communication path associated with the first game identifier is used to deliver advertising content and the communication path associated with the second game identifier is used to shut off all or certain types of advertising content delivery within the game. By way of a non-limiting example, the first game identifier identifies the game title and game platform, whilst the second game identifier is completely unique to the specific software package of that game title. The second game identifier is used to authenticate with an advertising broker site or with an ADSP directly, and to establish a communication path for providing a code or other data for shutting off delivery of user-specified advertising content types. For instance, the user pays to “upgrade” to a non-advertising enabled version of the game and receives a code. The code is provided from the game using the communication path that is associated with the completely unique second game identifier. Once the code is authenticated, no additional advertising content of the user-specified types is provided for display within the game.

### Example 5

A specific software package for a particular game title is provided with a plurality of different game identifiers, for instance two different game identifiers. A first game identifier of the plurality of different game identifiers is indicative of the game title and publisher, for instance. A second game identifier of the plurality of different game identifiers is indicative of a console type for which the specific software package is intended. Accordingly, the first game identifier is common to all software packages of the same game title that are published by a same publisher, regardless of the type of console the game is played on. However, all software packages of any game title that is intended to be played on a first console type have a common second game identifier, and all software packages of any game title that is intended to be played on a second console type have a different common second game identifier. A console provider may reserve a predetermined number of advertising spots in every one of their console game titles. The reserved advertising spots are associated with the second game identifier, such that content for display at the reserved advertising spots is provided via a dedicated communication path that is established when the second game identifier is provided to a remote server, such as for instance a server of the console provider. Accordingly, the reserved advertising spots cannot be disabled or filled with content other than that provided by the console provider. Optionally, the reserved advertising spots have uniform size and contextual properties so as to support display of standardized advertising content across a wide range of different game titles.

### Example 6

Multiple software packages of a first version of a game title are released, each one of the software packages of the first version having a first game identifier embedded into the software. Multiple software packages of a second version of the same game title are released, each one of the software packages of the second version having a second game identifier embedded into the software, the second game identifier different than the first game identifier. Optionally, the second version is released simultaneously with or at a time later than release of the first version.

For instance, a first version of a game title is released for sale at a price that is high. Users paying the high price for the first version obtain a software package having the first game identifier, which is indicative of the version and therefore the price that was paid. Accordingly, the amount of content that is delivered to a game that is identified as a first version is relatively small. At a later date, a second version of the game is released for sale at a price that is lower than that charged for the first version. Users paying the lower price for the second version obtain a software package having the second game identifier. Accordingly, the amount of content that is delivered to a game that is identified as a second version is relatively larger than the amount that is delivered to a game that is identified as a first version.

For instance, an English language version of a game title is released for sale and a French language version of the same game title is released simultaneously for sale. Each software package of the English language version includes a first game identifier, and each software package of the French language version includes a second game identifier. In a broker mediated advertising environment, when a game communicates with an advertising broker site and provides the first game identifier, the game is directed to an English language ADSP, or to an ADSP that hosts at least some English language content. Similarly, when a game communicates with an advertising broker site and provides the second game identifier, the game is directed to a French language ADSP, or to an ADSP that hosts at least some French language content. Alternatively, a bilingual version of the game title is released including both the first game identifier and the second game identifier, and the user selects a language preference during an initialization process. Based on the user-selected preference, the game provides an appropriate one of the first game identifier and the second game identifier.

### Example 7

At least some software packages of a game title are provided with a completely unique game identifier. For instance, individuals that are involved in the processes of selling or designing advertising content for being displayed within advertising spots of a video game title are provided with a personalized and fully functional version of the video game title. When the unique game identifier for the individual is provided to a server, the server responds by providing advertising content that is appropriate for the individual. For example, the individual determines in advance a plurality of advertising content pieces for being presented to a client. The plurality of advertising content pieces are not for being displayed to actual gamers, but are only for display during a “sales pitch” using a game that provides the unique game identifier for the individual. Advertising content that is not available for general viewing may nevertheless be displayed, thereby allowing the client to view their own advertising content within the context of an actual video game, rather than relying on screen shots or captured video clips containing the advertising content.

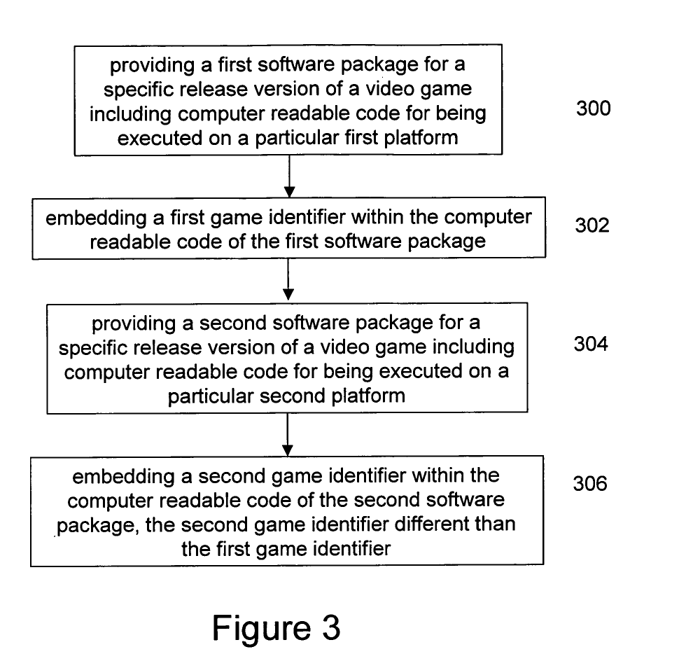

Referring now to FIG. 3, shown is a simplified flow diagram of a method according to an embodiment of the instant invention. At step 300 a first software package is provided for a specific release version of a video game for a particular first platform, the first software package including computer readable code for being executed on the particular first platform. At step 302 a first game identifier is embedded within the computer readable code of the first software package. At step 304 a second software package is provided for a specific release version of a video game for a particular second platform, the second software package including computer readable code for being executed on the particular second platform. At step 3006 a second game identifier is embedded within the computer readable code of the second software package, the second game identifier different than the first game identifier.

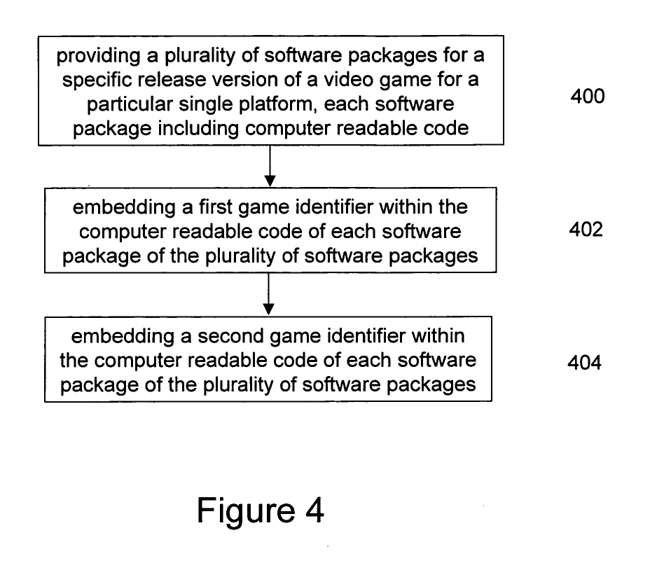

Referring now to FIG. 4, shown is a simplified flow diagram of another method according to an embodiment of the instant invention. At step 400 a plurality of software packages is provided for a specific release version of a video game for a particular single platform, each software package including computer readable code for being executed on the particular single platform. At step 402 a first game identifier is embedded within the computer readable code of each software package of the plurality of software packages. At step 404 a second game identifier is embedded within the computer readable code of each software package of the plurality of software packages.

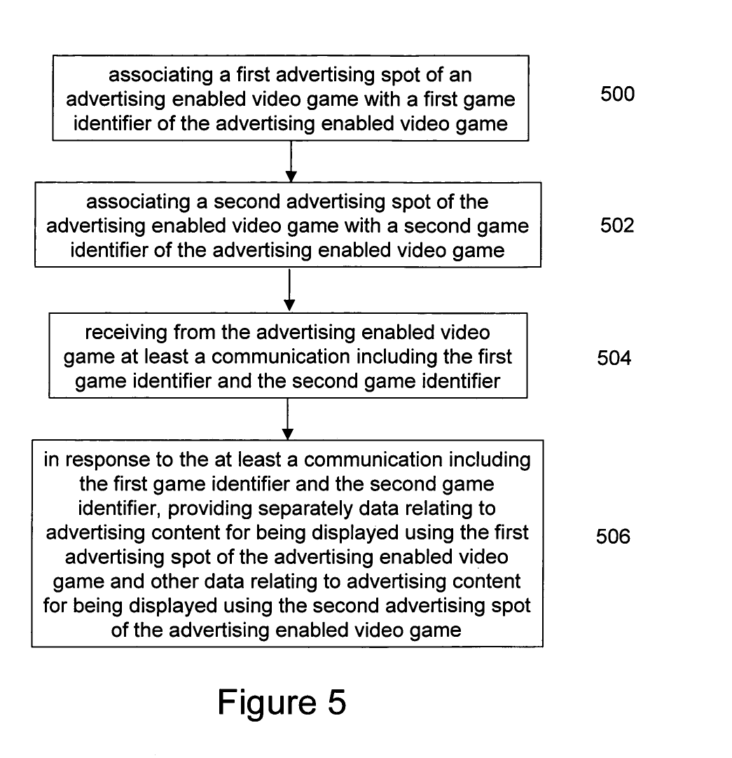

Referring now to FIG. 5, shown is a simplified flow diagram of yet another method according to an embodiment of the instant invention. At step 500 a first advertising spot of an advertising enabled video game is associated with a first game identifier of the advertising enabled video game. At step 502 a second advertising spot of the advertising enabled video game is associated with a second game identifier of the advertising enabled video game. At step 504, at least a communication including the first game identifier and the second game identifier is received from the advertising enabled video game. At step 506, in response to the at least a communication including the first game identifier and the second game identifier, data relating to advertising content for being displayed using the first advertising spot of the advertising enabled video game and other data relating to advertising content for being displayed using the second advertising spot of the advertising enabled video game is provided separately.

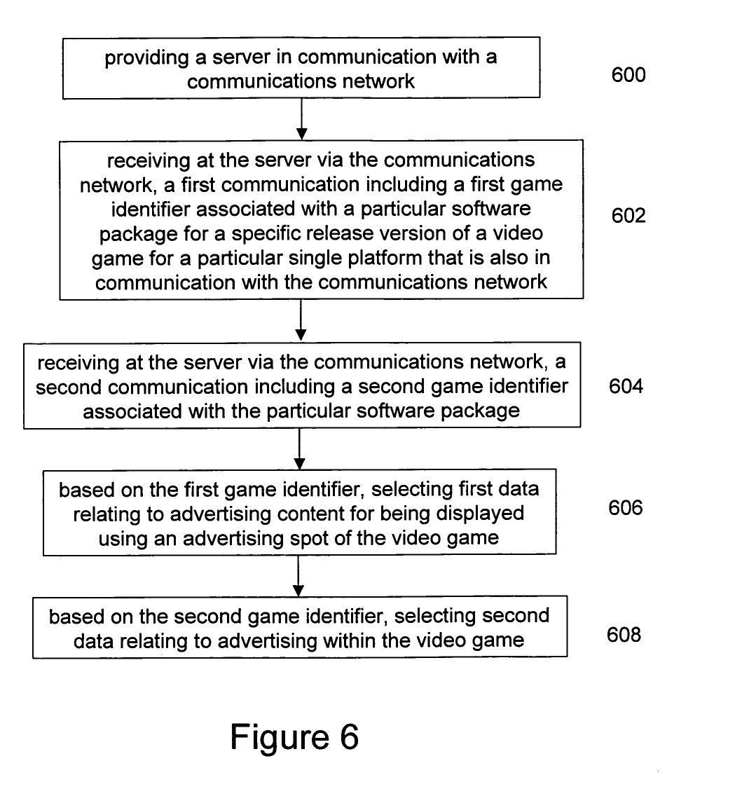

Referring now to FIG. 6, shown is a simplified flow diagram of yet another method according to an embodiment of the instant invention. At step 600 a server is provided in communication with a communications network. Step 602 is a step of receiving at the server via the communications network, a first communication including a first game identifier associated with a particular software package for a specific release version of a video game for a particular single platform that is also in communication with the communications network. Step 604 is a step of receiving at the server via the communications network, a second communication including a second game identifier associated with the particular software package. At step 606, based on the first game identifier, first data relating to advertising content for being displayed using an advertising spot of the video game is selected. At step 608, based on the second game identifier, second data relating to advertising within the video game is selected.

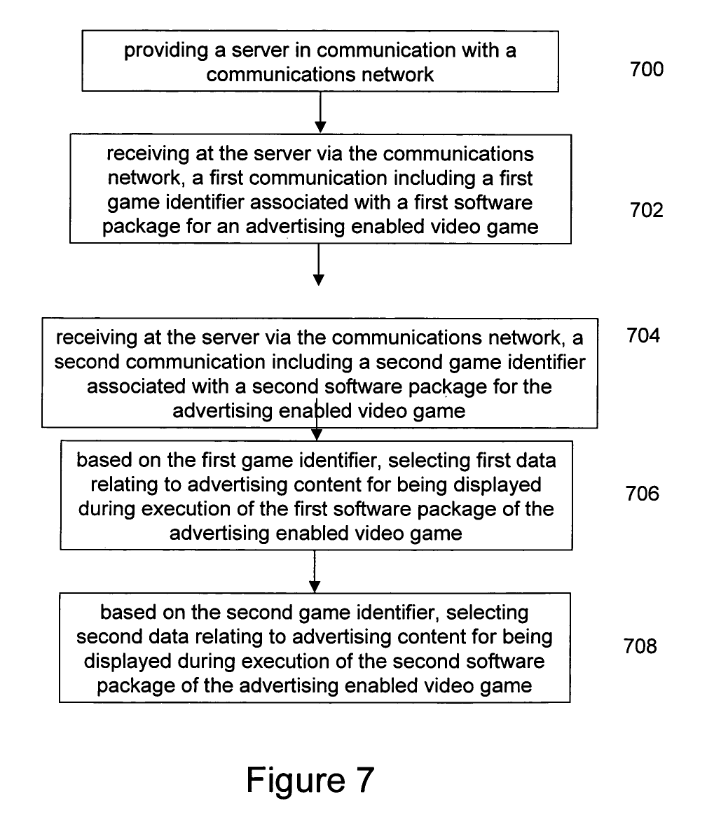

Referring now to FIG. 7, shown is a simplified flow diagram of yet another method according to an embodiment of the instant invention. At step 700 a server is provided in communication with a communications network. Step 702 is a step of receiving at the server via the communications network, a first communication including a first game identifier associated with a first software package for an advertising enabled video game. Step 704 is a step of receiving at the server via the communications network, a second communication including a second game identifier associated with a second software package for the advertising enabled video game. At step 706, based on the first game identifier, first data is selected relating to advertising content for being displayed during execution of the first software package of the advertising enabled video game. At step 708, based on the second game identifier, second data is selected relating to advertising content for being displayed during execution of the second software package of the advertising enabled video game.

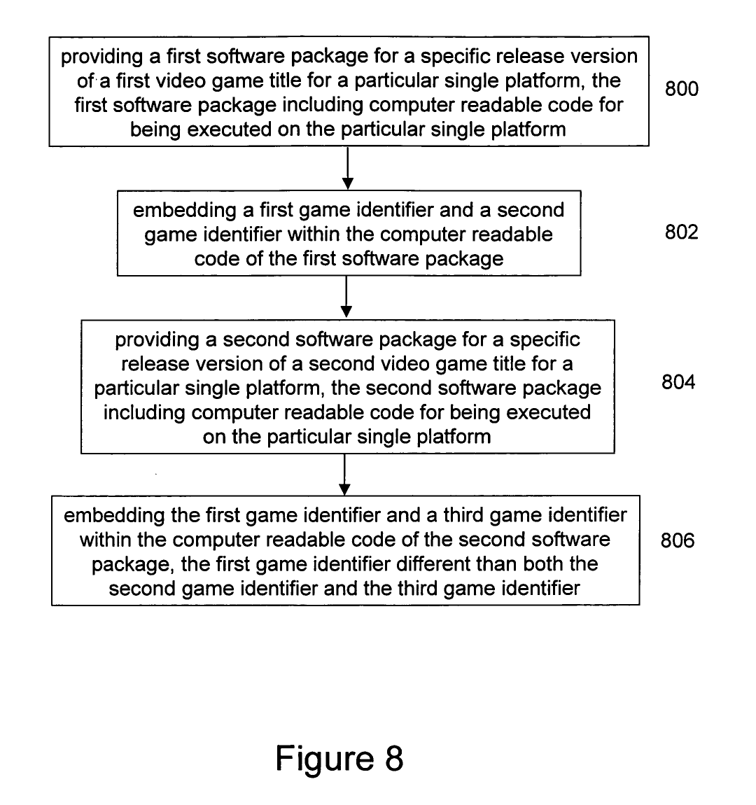

Referring now to FIG. 8, shown is a simplified flow diagram of yet another method according to an embodiment of the instant invention. At step 800 a first software package is provided for a specific release version of a first video game title for a particular single platform, the first software package including computer readable code for being executed on the particular single platform. Step 802 is a step of embedding a first game identifier and a second game identifier within the computer readable code of the first software package. At step 804 a second software package is provided for a specific release version of a second video game title for a particular single platform, the second software package including computer readable code for being executed on the particular single platform. Step 806 is a step of embedding the first game identifier and a third game identifier within the computer readable code of the second software package, the first game identifier different than both the second game identifier and the third game identifier.

Of course, the reference numerals referred to in the discussion of the methods according to FIGS. 3-8 are not intended to imply any particular order. In many cases method steps are optionally performed in an order that differs from an order that is presented in the specific, and non-limiting, examples of FIGS. 3-8.

Numerous other embodiments may be envisaged without departing from the spirit and scope of the instant invention. All specific examples have been provided for illustrative purposes only and are not intended to be limiting in any way.

What is claimed is:

1. A method for managing advertising content delivery in a gaming environment, comprising:
providing a first software package for a specific release version of a video game for a particular first platform, the first software package including computer readable code for being executed on the particular first platform;
embedding a first game identifier within the computer readable code of the first software package;
providing a second software package for a specific release version of a video game for a particular second platform, the second software package including computer readable code for being executed on the particular second platform; and,
embedding a second game identifier within the computer readable code of the second software package, the second game identifier different than the first game identifier.

2. A method according to claim 1, comprising embedding the second game identifier within the computer readable code of the first software package.

3. A method according to claim 2, comprising embedding the first game identifier within the computer readable code of the second software package.

4. A method according to claim 2, comprising embedding a third game identifier within the computer readable code of the second software package, the third game identifier different than both the first game identifier and the second game identifier.

5. A method according to claim 4, wherein the first software package is a software package of a first video game title and wherein the second software package is a software package of a second video game title.

6. A method according to claim 4, wherein the particular first platform is identical to the particular second platform.

7. A method according to claim 1, comprising embedding a third game identifier within the computer readable code of the first software package, the third game identifier different than both the first game identifier and the second game identifier.

8. A method according to claim 7, comprising embedding a fourth game identifier within the computer readable code of the second software package, the fourth game identifier different than each of the first game identifier, the second game identifier, and the third game identifier.

9. A method according to claim 1, wherein the specific release version of the first software package is different than the specific release version of the second software package.

10. A method according to claim 9, wherein the first game identifier is indicative of the specific release version of the first software package and wherein the second game identifier is indicative of the specific release version of the second software package.

11. A method according to claim 1, wherein the specific release version of the first software package is identical to the specific release version of the second software package.

12. A method according to claim 1, wherein the particular first platform is different than the particular second platform.

13. A method according to claim 12, wherein the first game identifier is indicative of the particular first platform and wherein the second game identifier is indicative of the particular second platform.

14. A method according to claim 1, wherein the particular first platform is identical to the particular second platform.

15. A method according to claim 14, comprising embedding the second game identifier within the computer readable code of the first software package.

16. A method according to claim 15, comprising embedding the first game identifier within the computer readable code of the second software package.

17. A method according to claim 15, comprising embedding a third game identifier within the computer readable code of the second software package, the third game identifier different than both the first game identifier and the second game identifier.

18. A method according to claim 15, comprising embedding a third game identifier within the computer readable code of the first software package, the third game identifier different than both the first game identifier and the second game identifier.

19. A method according to claim 18, comprising embedding a fourth game identifier within the computer readable code of the second software package, the fourth game identifier different than each of the first game identifier, the second game identifier, and the third game identifier.

20. A method according to claim 2, wherein the first game identifier is for supporting delivery of data relating to first advertising content and wherein the second game identifier is for supporting separate delivery of other data relating to second advertising content.

21. A method according to claim 7, wherein the first game identifier is for supporting delivery of data relating to first advertising content and wherein the third game identifier is for supporting separate delivery of other data relating to second advertising content.

22. A method for managing advertising content delivery in a gaming environment, comprising:
providing a plurality of software packages for a specific release version of a video game for a particular single platform, each software package including computer readable code for being executed on the particular single platform;
embedding a first game identifier within the computer readable code of each software package of the plurality of software packages; and,
embedding a second game identifier within the computer readable code of each software package of the plurality of software packages.

23. A method according to claim 22, wherein embedding a first game identifier within the computer readable code of each software package of the plurality of software packages comprises embedding a different first game identifier within each software package of the plurality of software packages.

24. A method according to claim 23, wherein embedding a second game identifier within the computer readable code of each software package of the plurality of software packages comprises embedding a different second game identifier within each software package of the plurality of software packages.

25. A method according to claim 22, comprising associating a first advertising spot of the specific release version of a video game with the first game identifier.

26. A method according to claim 25, comprising associating a second advertising spot of the specific release version of a video game with the second game identifier.

27. A method for managing advertising content delivery in a gaming environment, comprising:
associating a first advertising spot of an advertising enabled video game with a first game identifier of the advertising enabled video game;
associating a second advertising spot of the advertising enabled video game with a second game identifier of the advertising enabled video game;
receiving from the advertising enabled video game at least a communication including the first game identifier and the second game identifier; and,
in response to the at least a communication including the first game identifier and the second game identifier, providing separately data relating to advertising content for being displayed using the first advertising spot of the advertising enabled video game and other data relating to advertising content for being displayed using the second advertising spot of the advertising enabled video game.

28. A method for managing advertising content delivery in a gaming environment, comprising:
providing a server in communication with a communications network;
receiving at the server via the communications network, a first communication including a first game identifier associated with a particular software package for a specific release version of a video game for a particular single platform that is also in communication with the communications network;
receiving at the server via the communications network, a second communication including a second game identifier associated with the particular software package;
based on the first game identifier, selecting first data relating to advertising content for being displayed using an advertising spot of the video game; and,
based on the second game identifier, selecting second data relating to advertising within the video game.

29. A method according to claim 28, wherein the first communication and the second communication comprise a single aggregated communication event.

30. A method according to claim 28, wherein the selected second data relates to other advertising content for being displayed using another advertising spot of the video game.

31. A method according to claim 28, wherein the selected second data relates to a parameter for controlling display of the first data as advertising content within the video game.

32. A method according to claim 31, wherein the parameter relates to a frequency of display of the first data as advertising content within the video game.

33. A method according to claim 28, wherein the first game identifier is unique to the particular software package.

34. A method according to claim 33, wherein the second game identifier is common to a plurality of software packages including the particular software package.

35. A method according to claim 33, wherein the second game identifier is unique to the particular software package.

36. A method according to claim 28, wherein the first game identifier is unique to the specific release version of the particular software package.

37. A method according to claim 28, wherein the first game identifier is unique to the particular single platform.

38. A method according to claim 28, wherein the first game identifier is unique to a publisher of the video game.

39. A method according to claim 28, comprising providing separately from the server via the communications network, the selected first data and the selected second data.

40. A method according to claim 39, wherein the selected second data relates to other advertising content for being displayed using another advertising spot of the video game.

41. A method for managing advertising content delivery in a gaming environment, comprising:
providing a server in communication with a communications network;
receiving at the server via the communications network, a first communication including a first game identifier associated with a first software package for an advertising enabled video game;
receiving at the server via the communications network, a second communication including a second game identifier associated with a second software package for the advertising enabled video game;
based on the first game identifier, selecting first data relating to advertising content for being displayed during execution of the first software package of the advertising enabled video game; and,
based on the second game identifier, selecting second data relating to advertising content for being displayed during execution of the second software package of the advertising enabled video game.

42. A method according to claim 41, wherein the first software package and the second software package are different release versions of a same game title for a particular single platform.

43. A method according to claim 41, wherein the first software package is a software package of a game title for execution on a particular single platform, and wherein the second software package is a software package of a same game title for execution on a different particular single platform.

44. A method for managing advertising content delivery in a gaming environment, comprising:
providing a first software package for a specific release version of a first video game title for a particular single platform, the first software package including computer readable code for being executed on the particular single platform;
embedding a first game identifier and a second game identifier within the computer readable code of the first software package;
providing a second software package for a specific release version of a second video game title for a particular single platform, the second software package including computer readable code for being executed on the particular single platform; and,
embedding the first game identifier and a third game identifier within the computer readable code of the second software package, the first game identifier different than both the second game identifier and the third game identifier.
